(19) United States
(12) Patent Application Publication
(10) Pub. No.: US 2008/0214421 A1
(43) Pub. Date: Sep. 4, 2008

(54) CONTACT LENS CARE COMPOSITION

(76) Inventors: Fang Zhao, Rochester, NY (US); Shane Mao, Pittsford, NY (US); Kimberly Millard, Rochester, NY (US); Eric Phillips, Ontario, NY (US); Vicki Barniak, Fairport, NY (US)

Correspondence Address: Bausch & Lomb Incorporated, One Bausch & Lomb Place, Rochester, NY, 14604-2701, US

(21) Appl. No.: 12/030,987

(22) Filed: Feb. 14, 2008

Related U.S. Application Data
(60) Provisional application No. 60/890,540, filed on Feb. 19, 2007.

(51) Int. Cl. C11D 3/20

(52) U.S. Cl. 510/112

(57) ABSTRACT

A method of disinfecting, cleaning or packaging a contact lens by contacting the lens with an ophthalmically acceptable lens care composition. The composition comprises a fatty acid monoester and a cationic antimicrobial component. The fatty acid monoester comprises an aliphatic fatty acid portion having six to fourteen carbon atoms, and an aliphatic hydroxyl portion. The invention is also directed to an ophthalmically acceptable lens care composition comprising a fatty acid monoester and a cationic antimicrobial component.

This application claims priority under 35 U.S.C. § 119(e) to U.S. provisional application Ser. No. 60/890,540 filed Feb. 19, 2007.

The invention relates to a contact lens care composition comprising a fatty acid monoester and a cationic antimicrobial component (disinfectant), and the use of the composition to disinfect, clean or package a contact lens.

### BACKGROUND OF THE INVENTION

Generally, there are three categories of contact lenses: (1) hard lenses prepared from acrylic esters such as polymethyl methacrylate (PMMA), (2) rigid gas permeable (RGP) lenses prepared from silicone acrylates and fluorosilicone methacrylates, and (3) gel, hydrogel or soft type lenses. In the normal course of wearing contact lenses, tear film and debris consisting of proteinaceous, oily, sebaceous, and related organic matter will deposit and build up on the surface of a contact lens. Many factors influence deposit formation, including patient to patient variation, patient compliance with recommended procedures of care, lens material, care regimen and environment. In general, the high water (soft), lens materials absorb more protein than the low water (hard) lens materials. As a result, a routine care regimen is necessary in which the contact lenses are cleaned to remove these deposits. If the deposits are not properly removed, both the wettability and optical clarity of the lenses are substantially reduced and patient discomfort may result.

Disinfection of contact lenses is also necessary to kill harmful microorganisms that may be present or grow on the lenses. Some of the more popular products for disinfecting and cleaning lenses are referred to as multi-purpose solutions. Multi-purpose solutions are specifically formulated so a patient can place the contact lens on the eye without rinsing the lens. Such a solution, however, must be particularly gentle to the eye, because a residual amount of the multi-purpose solution will be on the lens when place on the eye.

British Patent No. 1,432,345 describes contact lens disinfecting solutions containing a polymeric biguanide and a mixed phosphate buffer. U.S. Pat. No. 4,758,595 to Ogunbiyi et al. describes a contact-lens solution containing a polyaminopropyl biguanide (PAPB), also known as polyhexamethylene biguanide (PHMB), which has enhanced efficacy when combined with a borate buffer. These disinfecting and preservative solutions are especially noteworthy for their broad spectrum of bactericidal and fungicidal activity at relatively low concentrations of antimicrobial components coupled with very low toxicity when used with soft-type contact lenses. Compositions containing PHMB and borate have been commercialized in various products including multi-purpose solutions, at levels of about 1 ppm or less for use with soft contact lenses.

The fact that multi-purpose solutions are designed for use without rinsing means that the solution must be ophthalmically safe for eye contact. This limits, to some extent the type and concentration of both cleaning agents and biocides that can be used in the solution. A challenge to the industry has been to develop a formula that is both an effective biocide, yet sufficiently gentle and comfortable to the patient (e.g., little or no stinging when initially placed onto the eye).

It is desirable to develop a contact lens composition with cleaning and disinfecting efficacy while (1) maintaining the biocidal efficacy of the product and (2) maintaining a low order of toxicity to eye tissue.

### SUMMARY OF THE INVENTION

The invention is directed to a method of disinfecting, cleaning or packaging a contact lens by contacting the lens with an ophthalmically acceptable solution. The solution comprises a fatty acid monoester and a cationic antimicrobial component. The fatty acid monoester comprises an aliphatic fatty acid portion having six to fourteen carbon atoms, and an aliphatic hydroxyl portion. The invention is also directed to an ophthalmically acceptable solution comprising the fatty acid monoester and a cationic antimicrobial component.

In one embodiment, the invention is directed to a method for enhancing the efficacy of a cationic disinfectant in a contact lens care formulation against Candida albicans or Fusarium solani. The method comprises adding a fatty acid monoester to a lens care formulation containing the cationic disinfectant selected from the group consisting of poly(hexamethylene biguanide), PHMB-CG*, α-[4-tris(2-hydroxyethyl) ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having ten carbon atoms and an aliphatic hydroxyl portion.

In another embodiment, the invention is directed to a method for enhancing the efficacy of a cationic disinfectant in a contact lens care formulation against Staphylococcus aureus, pseudomonas aeruginosa or Serratia marcescens or any combination thereof. The method comprises adding a fatty acid monoester to a lens care formulation containing the cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having eight carbon atoms and an aliphatic hydroxyl portion.

### DETAILED DESCRIPTION OF THE INVENTION

In general, disinfectants used in lens care solution products primarily exist in a cationic form (the antimicrobials have positive charge with a counter anion) at neutral pH. These include biguanides (e.g. PHMB and alexidine) and quaternary ammonium compounds (e.g. polyquarternium-1 and benzalkonium chloride). While the cationic antimicrobials are highly potent against a broad spectrum of microorganisms, their overall efficacy can be significantly impacted by other formulation components. For example, the antimicrobial activity of the cationic antimicrobials is highly sensitive to the presence of surfactants.

Lens uptake of the antimicrobial agent is another important issue to consider if cationic antimicrobials are used. Quaternary ammonium compounds such as benzalkonium chloride and cetrimide are known to bind irreversibly to certain lens materials and can result in severe eye irritation. The lens uptake also reduces the disinfecting efficacy of the solution upon storage of the lens in the lens case. This becomes a concern for noncompliant users. For example, topping off a used solution may not provide an adequate disinfecting efficacy.

The antimicrobial property of the fatty acid monoesters was first reported by Dr. Kabara in 1960s. Since then, activity against various microorganisms has been studied and reported. See, U.S. Pat. No. 4,002,775 which describes the antimicrobial activity of branched or unbranched, saturated or unsaturated fatty acid monoesters of twelve carbons. See, also G. Bergsson et al., in “In vitro killing of Candida albicans by fatty acids and monoglycerides”, Antimicrobial Agents and Chemotherapy, November 2001, 3209-12.

U.S. Pat. No. 5,624,958 to Isaacs et al. describes the use of medium chain length fatty acids and their corresponding monoglycerides as disinfecting agents in lens care compositions. There is no description, however, of using the medium chain length fatty acids and their corresponding monoglycerides to enhance the biocidal effect of a lens care solution that also contains a cationic antimicrobial component.

Accordingly, the invention is directed to contact lens care compositions that comprise fatty acid monoesters in combination with a cationic antimicrobial component in lens care solution products. The contact lens care compositions can be used to disinfect, clean or package contact lenses. The compositions also provide patients who use contact lenses with a high comfort level and acceptability, and therefore, the compositions can increase user compliance, which in turn promotes regular and consistent contact lens care, and ultimately leads to or facilitates better ocular health.

The invention is also directed to a method of disinfecting, cleaning or packaging a contact lens by contacting the lens with the ophthalmically acceptable, lens care compositions. The lens care compositions comprise a fatty acid monoester, in which the fatty acid monoester comprises an aliphatic fatty acid portion having six to fourteen carbon atoms, and an aliphatic hydroxyl portion. The compositions also comprise a cationic antimicrobial component.

The cationic antimicrobial component can be any ophthalmically acceptable, compound that is effective to disinfect a contact lens contacted with the lens care compositions. The term “ophthalmically acceptable” means that the component is compatible with ocular tissue, that is, it does not cause significant or undue detrimental effects when brought into contact with ocular tissue.

The term “aliphatic” refers to a straight or branched, saturated or unsaturated hydrocarbon. In one embodiment, the aliphatic fatty acid portion is a straight chain, saturated or unsaturated hydrocarbon with eight to ten carbons.

In another embodiment, the aliphatic fatty acid portion is a branched chain, saturated or unsaturated hydrocarbon with eight to ten carbons. For example, a 5-ethyl substituted derivative of decanoylglycerol can be used.

Furthermore, if the fatty acid portion is unsaturated, it is preferred that the fatty acid is monounsaturated, with the cis-form being preferred over the trans-form.

The aliphatic hydroxyl portion of the fatty acid monoester can be any aliphatic compound with at least one hydroxyl group, preferably with at least two hydroxyl groups. In many of the embodiments, the aliphatic hydroxyl portion will have from three to nine carbons.

The aliphatic hydroxyl portion includes, but is not limited to, propylene glycol, glycerol, a polyalkylene glycol, e.g., polyethylene glycol or polypropylene glycol, a cyclic polyol, e.g., sorbitan, glucose, mannose, sucrose, fructose, fucose and inisitol and derivatives thereof, and a linear polyol, e.g., mannitol and sorbitol and derivatives thereof. In a preferred embodiment the aliphatic hydroxyl portion is glycerol.

The cationic antimicrobial components include chemicals which derive their antimicrobial activity through a chemical or physiochemical interaction with microbes or microorganisms normally associated with contaminating a contact lens. Suitable antimicrobial components include, but are not limited to, quaternary ammonium salts used in ophthalmic applications such as poly[dimethylimino-2-butene-1,4-diyl]chloride, α-[4-tris(2-hydroxyethyl)ammonium chloride-2-butenyl]poly[1-dimethylammonium chloride-2-butenyl]-ω-tris(2-hydroxyethyl) ammonium chloride (CAS# 68518-54-7, available as Polyquatemium-1® from Onyx Corporation), myristamidopropyl dimethylamine (Aldox®), benzalkonium halides, and biguanides such as salts of alexidine, alexidine-free base, salts of chlorhexidine, hexamethylene biguanides and salts thereof and their polymers, antimicrobial polypeptides and mixtures thereof.

The term “cationic” when referring to an antimicrobial component refers to the predominant form of the antimicrobial component at neutral pH having a positive charge and a counteranion. An exemplary list of cationic disinfecting antimicrobial components include poly[dimethylimino-2-butene-1,4-diyl]chloride, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine, poly(hexamethylene biguanide) (PHMB), PHMB-CG* and any mixture thereof.

PHMB is best described as a polymeric biguanide composition comprising at least three biguanide polymers, which we refer to as PHMB-A, PHMB-CG and PHMB-CGA, the general chemical structures of which are depicted below.

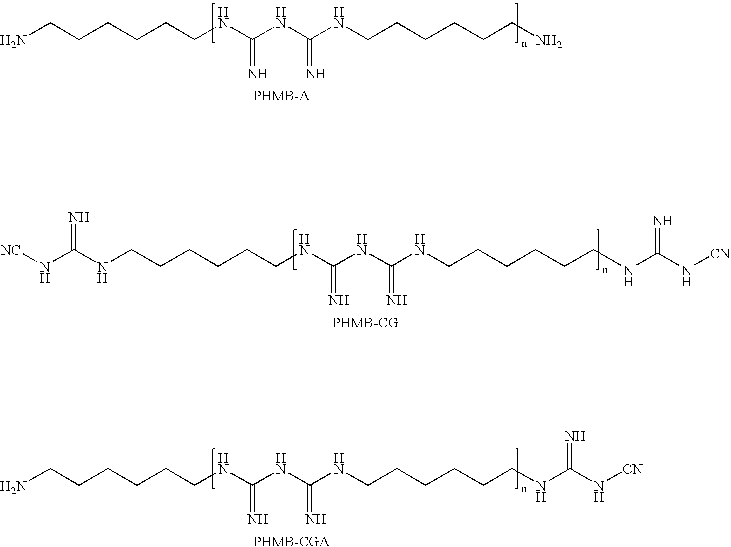

For each of these polymers, “n” represents the average number of repeating groups. Actually, a distribution of polymer length would exist for each of the polymers shown. The prior synthetic routes to PHMB provided a polymeric biguanide composition with about 50% by weight of the polymeric composition as PHMB-CGA, that is, having a cyanoguanidino end cap on one end and a diamine on the other end, about 25% by weight PHMB-A and about 25% by weight PHMB-CG. Given this approximate weight ratio of the three major PHMB polymers above, the percentage of cyanoguardino end caps is also about 50% of the total number of terminal groups. In this application we refer to this conventional polymeric biguanide composition as poly(hexamethylene biguanide) or PHMB.

A new synthetic route to polymeric biguanide compositions is described in copending U.S. provisional application Ser. No. 60/853,579 filed Oct. 23, 2006, the entire disclosure of which is incorporated herein by reference. The new synthetic route provides a polymeric biguanide composition with relatively greater number of cyanoguardino end groups. Typically, the number percent of cyanoguardino end groups can be increased to greater than 60%. In this application we refer to this novel polymeric biguanide composition as PHMB-CG*. We also refer to polymeric biguanide compositions in the generic sense as “hexamethylene biguanides”, which one of ordinary skill in the art would recognize to include both PHMB as well as PHMB-CG*.

The cationic antimicrobial component is present in an amount from 0.01 ppm to 100 ppm, from 0.1 ppm to 50 ppm or from 0.1 ppm to 10 ppm. It is preferred, however, that the amount of antimicrobial component that is used is effective in disinfecting contact lenses contacted with the compositions, while at the same time promote lens patient comfort and acceptability. Typically, an amount of the antimicrobial component is used to reduce the microbial burden or load on the contact lens by one log order in four hours. More preferably, an effective amount of the antimicrobial component reduces the microbial load by one log order in one hour. The reductions are based upon similarly prepared lens solutions absent the cationic antimicrobial component.

In one embodiment, the primary antimicrobial component present in the lens care compositions is poly(hexamethylene biguanide) or PHMB-CG*, which is present from 0.01 ppm to 3 ppm. In another embodiment, the primary antimicrobial component present in the lens care compositions is α-[4-tris(2-hydroxyethyl)ammonium chloride-2-butenyl]poly[1-dimethylammonium chloride-2-butenyl]-ω-tris(2-hydroxyethyl)ammonium chloride, which is present from 1 ppm to 100 ppm.

Any one mixture of the two cationic antimicrobial components can also be present in the lens care compositions. For example, a particular lens care composition can include from 0.3 ppm to 0.8 ppm PHMB or PHMB-CG*, and 10 ppm to 60 ppm α-[4-tris(2-hydroxyethyl)ammonium chloride-2-butenyl]poly[1-dimethylammonium chloride-2-butenyl]-ω-tris(2-hydroxyethyl)ammonium chloride.

In one embodiment, the invention is directed to a method for enhancing the efficacy of a cationic disinfectant in a contact lens care formulation. The method comprises adding a fatty acid monoester to a lens care formulation containing the cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having ten carbon atoms, and an aliphatic hydroxyl portion. This lens care formulation exhibits an enhanced efficacy against Candida albicans or Fusarium solani. The method has proven to be quite advantageous if the cationic disinfectant is poly(hexamethylene biguanide) or PHMB-CG*.

Accordingly, the invention is also directed to an ophthalmically acceptable, lens care composition comprising: a fatty acid monoester, and a cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having ten carbon atoms, and an aliphatic hydroxyl portion. The ophthalmically acceptable, lens care composition is further characterized by an enhanced efficacy against Candida albicans or Fusarium solani.

In another embodiment, the invention is directed to a method for enhancing the efficacy of a cationic disinfectant in a contact lens care formulation. The method comprises adding a fatty acid monoester to a lens care formulation containing the cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having eight carbon atoms, and an aliphatic hydroxyl portion. This lens care formulation exhibits an enhanced efficacy against Staphylococcus aureus, pseudomonas aeruginosa or Serratia marcescens or any combination thereof.

Accordingly, the invention is also directed to an ophthalmically acceptable, lens care composition comprising: a fatty acid monoester, and a cationic disinfectant selected from the group consisting of poly(hexamethylene biguanide, PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine and any mixture thereof. The fatty acid monoester comprises an aliphatic fatty acid portion having eight carbon atoms, and an aliphatic hydroxyl portion. The ophthalmically acceptable, lens care composition is further characterized by an enhanced efficacy against Staphylococcus aureus, pseudomonas aeruginosa or Serratia marcescens or any combination thereof.

The lens care compositions can also include a phosphonic acid, or its physiologically compatible salt, that is represented by the following formula:

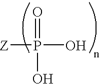

wherein Z is a connecting radical equal, n is an integer from 1 to 4, or 1, 2 or 3, and preferably containing 1 to 12 carbon atoms, more preferably 3 to 10 carbon atoms. The Z radical comprises substituted or unsubstituted saturated hydrocarbon radicals or amine-containing radicals, which amine-containing radicals are saturated hydrocarbon radicals in which the carbon atoms are interrupted with at least one nitrogen atom such as 1, 2 or 3 nitrogen atoms that forms a secondary or tertiary amine.

Accordingly, suitable Z radicals include substituted or unsubstituted alkylidene, substituted or unsubstituted alkylene, amino tri(alkylene) having at least n+1 carbon atoms, amino di(alkylene) having at least n+1 carbon atoms, alkylenediaminetetra(alkylene) or a dialkylenetriamine penta(alkylene) radical. In each case, the alkylene group in parenthesis is connected to a phosphonic acid group. Preferably, all alkylene groups independently have 1 to 4 carbon atoms.

Exemplary compounds in which the Z group is an amino tri(alkylene) radical includes amino tri(ethylidene phosphonic acid), amino tri(isopropylidene phosphonic acid), amino di(methylene phosphonic acid) mono(isopropylidene phosphonic acid), and amino mono(methylene phosphonic acid) di(ethylidene phosphonic acid). Exemplary compounds in which the Z group is a substituted or unsubstituted alkylidene radical includes methylene diphosphonic acid, ethylidine diphosphonic acid, 1-hydroxy propylidene diphosphonic acid. Exemplary compounds in which the Z group is an alkylenediaminetetra(alkylene) or a dialkylenetriamine penta(alkylene) radical include hexamethylenediaminetetra(methylene phosphonic acid) and diethylenetriaminepenta(methylenephosphonic acid).

In one embodiment, the phosphonic acid, or its physiologically compatible salt, is represented by the following formula:

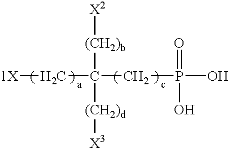

wherein each of a, b, c, and d are independently selected from integers from 0 to 4, preferably 0 or 1; X¹ is a phosphonic acid group (i.e., P(OH)₂O), hydroxy, amine or hydrogen; and X² and X³ are independently selected from the group consisting of halogen, hydroxy, amine, carboxy, alkylcarbonyl, alkoxycarbonyl, or substituted or unsubstituted phenyl, and methyl. Exemplary substituents on the phenyl are halogen, hydroxy, amine, carboxy and/or alkyl groups. A particularly preferred species is that wherein a, b, c, and d in are zero, specifically the tetrasodium salt of 1-hydroxyethylidene-1,1-diphosphonic acid, also referred to as tetrasodium etidronate, commercially available from Monsanto Company as DeQuest® 2016 diphosphonic acid sodium salt or phosphonate.

The lens care compositions can also include dexpanthenol, which is an alcohol of pantothenic acid, also called Provitamin B5, D-pantothenyl alcohol or D-panthenol. In some formulations of the lens care compositions, dexpanthenol can exhibit good cleansing action and can stabilize the lachrymal film at the eye surface when placing a contact lens on the eye. Dexpanthenol is preferably present in the contact lens care compositions in an amount from 0.2% to 10% (w/v), from 0.5% to 5% (w/v), or from 1% to 3% (w/v).

The lens care compositions can also include sorbitol, which is a hexavalent sugar alcohol. Typically, dexpanthenol is used in combination with sorbitol. In specific formulations the combination dexpanthenol and sorbitol can provide enhanced cleansing action and can also stabilize the lachrymal film following placement of the contact lens on the eye. These formulations can substantially improve patient comfort when wearing contact lenses. Sorbitol is present in the lens care compositions in an amount from 0.4% to 10% (w/v), from 0.8% to 6% (w/v) or from 1% to 3% (w/v).

The lens care compositions can also include one or more neutral or basic amino acids. The neutral amino acids include: the alkyl-group-containing amino acids such as alanine, isoleucine, valine, leucine and proline; hydroxyl-group-containing amino acids such as serine, threonine and 4-hydroxyproline; thio-group-containing amino acids such as cysteine, methionine and asparagine. Examples of the basic amino acid include lysine, histidine and arginine. The one or more neutral or basic amino acids are present in the compositions at a total concentration of from 0.1% to 5% (w/v).

The lens care compositions can also include glycolic acid, asparatic acid or any mixture of the two at a total concentration of from 0.001% to 4% (w/v) or from 0.01% to 2.0% (w/v).

Further, the combined use of one or more amino acids and glycolic acid and/or asparatic acid can lead to a reduction in the change of the size of the contact lens due to swelling and shrinkage following placement of the lens on the eye. The stated combination provides a higher degree of compatibility with the contact lens compared to the absence of one of the two components in the composition. It is believed that one or more of the amino acids can cause the lens to swell, and that the glycolic acid and/or asparatic acid can cause the contact lens to shrink. If used in combination, however, a mutual counteraction of the two observed affects is believed to exist.

The lens care compositions can also include glycolic acid, asparatic acid or any mixture of the two, in combination with 2-amino-2-methyl-1,3-propanediol or a salt thereof. One observed advantage is that compositions that contain a mixture of two of the three, or all three, compounds minimizes the change of the lens size following placement of the contact lens in the eye. It is also believed that the stated combination of compounds minimizes the amount of uptake of the cationic antimicrobial component, particularly, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine, benzalkonium halides, alexidine and salts thereof, salts of chlorhexidine, hexamethylene biguanides and salts thereof and their polymers such as poly(hexamethylene biguanide) or PHMB-CG*.

The 2-amino-2-methyl-1,3-propanediol (AMPD) or the salt thereof is added to the compositions in an amount to satisfy a predetermined molar ratio of glycolic acid, asparatic acid or any mixture of the two and AMPD. The molar ratio of the two components glycolic acid and/or asparatic acid to AMPD is 1:20 to 1.3:1. The glycolic acid, asparatic acid or any mixture of the two is present in the compositions at a concentration of 0.01% to 5% (w/v) or at a concentration of 0.05% to 1% (w/v).

If the components glycolic acid and/or asparatic acid, and AMPD, are present in the compositions in the absence of the other, one may observe a tendency to cause shrinkage or swelling of the lens. However, if these two components are combined together and used in the predetermined molar ratio, little, if any, change in the size of the lens is observed.

The amount of AMPD present in the compositions can be determined according to the amount of glycolic acid and/or asparatic acid in the composition. As stated, AMPD is present in an amount to provide a molar ratio of glycolic acid and/or asparatic acid to AMPD to be from 1:20 to 1.3:1, from 1:15 to 1.2:1 or from 1:14 to 1:1. If the amount of AMPD exceeds 20 mols per 1 mol of glycolic acid and/or asparatic, adsorption of the cationic antimicrobial component on the contact lens will occur. If the amount of AMPD is less than 1 mol per 1.3 mols of glycolic acid and/or asparatic acid, a reduction in antimicrobial efficacy of the composition is observed.

The contact lens care compositions will very likely include a buffer system. By the terms “buffer” or “buffer system” is meant a compound that, usually in combination with at least one other compound, provides a buffering system in solution that exhibits buffering capacity, that is, the capacity to neutralize, within limits, either acids or bases (alkali) with relatively little or no change in the original pH. Generally, the buffering components are present from 0.05% to 2.5% (w/v) or from 0.1% to 1.5% (w/v).

The term “buffering capacity” is defined to mean the millimoles (mM) of strong acid or base (or respectively, hydrogen or hydroxide ions) required to change the pH by one unit when added to one liter (a standard unit) of the buffer solution. The buffer capacity will depend on the type and concentration of the buffer components. The buffer capacity is measured from a starting pH of 6 to 8, preferably from 7.4 to 8.4.

Borate buffers include, for example, boric acid and its salts, for example, sodium borate or potassium borate. Borate buffers also include compounds such as potassium tetraborate or potassium metaborate that produce borate acid or its salt in solutions. Borate buffers are known for enhancing the efficacy of certain polymeric biguanides. For example, U.S. Pat. No. 4,758,595 to Ogunbiyi et al. describes that a contact-lens solution containing a polyaminopropyl biguanide (PAPB), also known as PHMB, can exhibit enhanced efficacy if combined with a borate buffer.

A phosphate buffer system preferably includes one or more monobasic phosphates, dibasic phosphates and the like. Particularly useful phosphate buffers are those selected from phosphate salts of alkali and/or alkaline earth metals. Examples of suitable phosphate buffers include one or more of sodium dibasic phosphate (Na₂HPO₄), sodium monobasic phosphate (NaH₂PO₄) and potassium monobasic phosphate (KH₂PO₄). The phosphate buffer components frequently are used in amounts from 0.01% or to 0.5% (w/v), calculated as phosphate ion.

Other known buffer compounds can optionally be added to the lens care compositions, for example, citrates, citric acid, sodium bicarbonate, TRIS, and the like. Other ingredients in the solution, while having other functions, may also affect the buffer capacity. For example, EDTA, often used as a complexing agent, can have a noticeable effect on the buffer capacity of a composition.

A preferred buffer system is based upon boric acid/borate, a mono and/or dibasic phosphate salt/phosphoric acid or a combined boric/phosphate buffer system. For example a combined boric/phosphate buffer system can be formulated from a mixture of sodium borate and phosphoric acid, or the combination of sodium borate and the monobasic phosphate.

In a combined boric/phosphate buffer system, the solution comprises about 0.05 to 2.5% (w/v) of a phosphoric acid or its salt and 0.1 to 5.0% (w/v) of boric acid or its salt. The phosphate buffer is used (in total) at a concentration of 0.004 to 0.2 M (Molar), preferably 0.04 to 0.1 M. The borate buffer (in total) is used at a concentration of 0.02 to 0.8 M, preferably 0.07 to 0.2 M.

The lens care compositions can also include a water-soluble borate-polyol complex which can be formed by mixing a source of borate with a polyol of choice in an aqueous solution. These complexes can be used in conjunction with the cationic antimicrobial component above, and can help to meet preservative efficacy and disinfection standards. In such compositions, the molar ratio of borate to polyol is generally from 1:0.1 to 1:10, or from 1:0.25 to 1:2.5. If present in the lens care compositions, the borate-polyol complex is usually present from 0.5% to 5% (w/v), from 1.0% to 2.5% (w/v). The borate-polyol complexes are described in greater detail in U.S. Pat. No. 6,143,799.

The lens care compositions will very likely comprise effective amounts of one or more known lens care formulation components such as a detergent or surfactant component, a viscosity inducing or thickening component. a chelating or sequestering component, or a tonicity component. The additional component or components can be selected from materials which are known to be useful in contact lens care compositions and are included in amounts effective to provide the desired effect or benefit. When an additional component is included, it is preferably compatible under typical use and storage conditions with the other components of the composition.

Suitable surfactants can be either amphoteric, cationic, anionic, or nonionic, and are typically present (individually or in combination) in amounts up to 15%, or up to 5% (w/v). One preferred surfactant class is the amphoteric or nonionic surfactants. The surfactant should be soluble in the lens care solution and non-irritating to eye tissues. Many nonionic surfactants comprise one or more chains or polymeric components having oxyalkylene (—O—R—) repeats units wherein R has 2 to 6 carbon atoms. Preferred non-ionic surfactants comprise block polymers of two or more different kinds of oxyalkylene repeat units, which ratio of different repeat units determines the HLB of the surfactant. Satisfactory non-ionic surfactants include polyethylene glycol esters of fatty acids, e.g. coconut, polysorbate, polyoxyethylene or polyoxypropylene ethers of higher alkanes (C₁₂-C₁₈). Examples of the this class include polysorbate 20 (available under the trademark Tween® 20), polyoxyethylene (23) lauryl ether (Brij(t 35), polyoxyethyene (40) stearate (Myrj®52), polyoxyethylene (25) propylene glycol stearate (Atlas® G 2612). Still other preferred surfactants include tyloxapol, betaine-type surfactants, polysulfates, polyethylene glycol, alkyl esters and any mixture thereof.

A particular non-ionic surfactant consisting of a poly(oxypropylene)-poly(oxyethylene) adduct of ethylene diamine having a molecular weight from about 7,500 to about 27,000 wherein at least 40 weight percent of said adduct is poly(oxyethylene) has been found to be particularly advantageous for use in cleaning and conditioning both soft and hard contact lenses when used in amounts from about 0.01 to about 15 weight percent. The CTFA Cosmetic Ingredient Dictionary's adopted name for this group of surfactants is poloxamine. Such surfactants are available from BASF Wyandotte Corp., Wyandotte, Mich., under Tetronic®.

An analogous of series of surfactants, for use in the lens care compositions, is the poloxamer series which is a poly(oxyethylene) poly(oxypropylene) block polymers available under Pluronic® (commercially available form BASF). In accordance with one embodiment of a lens care composition the poly(oxyethylene)-poly(oxypropylene) block copolymers will have molecular weights from 2500 to 13,000 daltons or from 6000 to about 12,000 daltons. Specific examples of surfactants which are satisfactory include: poloxamer 108, poloxamer 188, poloxamer 237, poloxamer 238, poloxamer 288 and poloxamer 407. Particularly good results are obtained with poloxamer 237.

Various other ionic as well as amphoteric and anionic surfactants suitable for in the invention can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Amphoteric surfactants suitable for use in a composition according to the present invention include materials of the type are offered commercially under the trade name “Miranol.” Another useful class of amphoteric surfactants is exemplified by cocoamidopropyl betaine, commercially available from various sources.

The foregoing surfactants will generally be present in a total amount from 0.01% to 5% (w/v), from 0.1% to 5% (w/v), or from 0.1% to 1.5% (w/v). Often the amount of surfactant is from 0.005% or 0.01%, to 0.1% or 0.5% or 0.8% (w/v).

The viscosity inducing components used in the lens care compositions are compatible with the other components and are preferably nonionic. Such viscosity inducing components are effective to enhance and/or prolong the cleaning and wetting activity of the surfactant component and/or condition the lens surface rendering it more hydrophilic (less lipophilic) and/or to act as a demulcent on the eye. Increasing the solution viscosity provides a film on the lens which may facilitate comfortable wearing of the contact lens. The viscosity inducing component can also function to cushion the impact on the eye surface during placement of the lens and serves also to alleviate eye irritation.

Suitable viscosity inducing components include, but are not limited to, water soluble natural gums, cellulose-derived polymers and the like. Useful natural gums include guar gum, gum tragacanth and the like. Useful cellulose-derived viscosity inducing components include cellulose-derived polymers, such as hydroxypropyl cellulose, hydroxypropylmethyl cellulose, carboxymethyl cellulose, methyl cellulose, hydroxyethyl cellulose and the like. A very useful viscosity inducing component is hydroxypropylmethyl cellulose (HPMC).

The viscosity inducing component is used in an amount effective to increase the viscosity of the solution, preferably to a viscosity in the range of about 1.5 to about 30, or even as high as about 750, cps at 25° C., as determined by USP test method No. 911 (USP 23, 1995).

A chelating or sequestering can be included in an amount effective to enhance the effectiveness of the cationic antimicrobial component and/or to complex with metal ions to provide more effective cleaning of the contact lens. A wide range of organic acids, amines or compounds which include an acid group and an amine function are capable of acting as chelating components in the present compositions. For example, nitrilotriacetic acid, diethylenetriaminepentacetic acid, hydroxyethylethylene-diaminetriacetic acid, 1,2-diaminocyclohexane tetraacetic acid, hydroxyethylaminodiacetic acid, ethylenediamine-tetraacetic acid and its salts, polyphosphates, citric acid and its salts, tartaric acid and its salts, and the like and mixtures thereof, are useful as chelating components. Ethylenediaminetetraacetic acid (EDTA) and its alkali metal salts, are preferred, with disodium salt of EDTA, also known as disodium edetate, being one of the preferred chelating components.

The lens care compositions will typically have an osmolality in the range of at least about 200 mOsmol/kg for example, about 300 or about 350 to about 400 mOsmol/kg. The lens care compositions are substantially isotonic or hypertonic (for example, slightly hypertonic) and are ophthalmically acceptable.

The lens care compositions will typically include an effective amount of a tonicity adjusting component. Among the suitable tonicity adjusting components that can be used are those conventionally used in contact lens care products such as various inorganic salts. Sodium chloride and/or potassium chloride and the like are very useful tonicity components. The amount of tonicity adjusting component is effective to provide the desired degree of tonicity to the solution.

The contact lens can be contacted with the lens care compositions by immersing the lens in the compositions. During at least a portion of the contacting, the lens container holding the contact lens can be agitated, for example, by shaking the container to at least facilitate removal of deposit material from the lens. After such contacting step, the contact lens can be manually rubbed to remove further deposit material from the lens. The cleaning method can also include rinsing the lens substantially free of the lens care compositions prior to placing the lens on the eye.

The lens care compositions can be used with all categories of contact lenses such as hard, soft, rigid and soft gas permeable, and silicone (including both hydrogel and non-hydrogel) lenses. The compositions, however, are particularly formulated for uses with soft lenses, including soft silicone lenses. Many of these soft lenses, especially those formulated for extended wear, are presently prepared from high-Dk silicone-containing materials.

The lens care compositions are particularly formulated as a multi-purpose solution. The multi-purpose solutions will typically include one or more antimicrobial components in sufficient concentrations to destroy harmful microorganisms on the surface of a contact lens within the recommended minimum soaking time. The recommended minimum soaking time is included in the package instructions for use of the lens care compositions.

The use of the term “multi-purpose solutions” does not exclude the possibility that some patients, for example, patients particularly sensitive to chemical disinfectants or other chemical agents, may prefer to rinse or wet a contact lens with another solution, for example, a sterile saline solution prior to positioning of the lens on the eye. The term “multi-purpose solution” also does not exclude the possibility of periodic cleaners not used on a daily basis or supplemental cleaners for removing proteins, for example enzyme cleaners, which are typically used on a weekly basis.

The lens compositions can also be formulated as a preserving solution, a cleaning solution or as a storage solution for contact lenses. One of ordinary skill in the art would know how to adjust the formulation for each of these respective applications. The lens care compositions in combination with its container or bottle and packaging, including instructions for use in accordance with a specified regimen, provides an improved kit, package, or system for the care of contact lenses.

The following non-limiting examples illustrate certain aspects of the present invention.

### EXAMPLE 1

The formulations described in Tables 1, 2, 3 and 4 were prepared by dissolving all the ingredients in the order listed. Each ingredient was allowed to dissolve fully before the next ingredient was added.

### EXAMPLE. 2

The disinfection efficacy of the formulations was tested following the Stand-alone Biocidal procedure outlined in ISO 14729, International Standardized Document for Ophthalmic Optics and FDA Premarket Notification (510k) Guidance Document for Contact Lens Care Products. The results are reported in Tables A, B, C and D. The organisms used are listed below.

Sa; Staphylococcus aureus (ATCC 6538)
Pa; Pseudomonas aeruginosa (ATCC 9027)
Sm; Serratia marcescens (ATCC 13880)
Ca; Candida albicans (ATCC 10231)
Fs; Fusarium solani (ATCC 36031)

TABLE 1
Formulations containing PHMB and decanoylglycerol.

| | % w/w | | |
|---|---|---|---|
| Ingredient | Formulation 1a | Formulation 1b | Formulation 1c |
| Boric acid | 0.64 | 0.64 | 0.64 |
| Sodium borate | 0.09 | 0.09 | 0.09 |
| Sodium chloride | 0.49 | 0.49 | 0.49 |
| Disodium edetate | 0.10 | 0.10 | 0.10 |
| Hydroxyalkyl | 0.03 | 0.03 | 0.03 |
| phosphonate | | | |
| Poloxamine 1107 | 1.00 | 1.00 | 1.00 |
| Decanoylglycerol | — | 250 ppm | 250 ppm |
| PHMB | 0.5 ppm | — | 0.5 ppm |
| Water | q.s. to 100% | q.s. to 100% | q.s. to 100% |
| pH | 7.1-7.5 | 7.1-7.5 | 7.1-7.5 |
| Osmolality, mOsm/kg | 280-320 | 280-320 | 280-320 |

TABLE A
Biocidal efficacy of formulations 1a, 1b and 1c.

| Formulation^{a} | Time, hr | Sa | Pa | Sm | Ca | Fs |
|---|---|---|---|---|---|---|
| 1a | 0.5 | 3.0 | 4.3 | >4.9 | 0.5 | 0.2 |
| | 4 | >4.8 | >4.8 | >4.9 | 1.5 | 1.3 |
| 1b | 0.5 | 0.9 | ND | 1.1 | 0.3 | 0.3 |
| | 4 | 1.8 | ND | 1.8 | 1.3 | 2.0 |
| 1c | 0.5 | >4.8 | >4.8 | >4.9 | 0.9 | 1.1 |
| | 4 | >4.8 | >4.8 | >4.9 | 3.8 | 4.8 |

^{a}All samples were tested with 10% organic soil.

As indicated by the data of Table A, the effect of adding decanoylglycerol to a lens care formulation containing poly(hexamethylene biguanide) is particularly effective against three microorganisms, Sa, Ca, and Fs.

TABLE 2
Formulations containing Polyquaternium-1 and decanoylglycerol.

| | % w/w | | |
|---|---|---|---|
| Ingredient | Formulation 2a | Formulation 2b | Formulation 2c |
| Boric acid | 0.64 | 0.64 | 0.64 |
| Sodium borate | 0.09 | 0.09 | 0.09 |
| Sodium chloride | 0.49 | 0.49 | 0.49 |
| Disodium edetate | 0.10 | 0.10 | 0.10 |
| Hydroxyalkyl | 0.03 | 0.03 | 0.03 |
| phosphonate | | | |
| Poloxamine 1107 | 1.00 | 1.00 | 1.00 |
| Decanoylglycerol | — | 250 ppm | 250 ppm |
| Polyquaternium-1 | 10 ppm | — | 10 ppm |
| Water | q.s. to 100% | q.s. to 100% | q.s. to 100% |
| pH | 7.1-7.5 | 7.1-7.5 | 7.1-7.5 |
| Osmolality, mOsm/kg | 280-320 | 280-320 | 280-320 |

TABLE B
Biocidal efficacy of formulations 2a, 2b and 2c.

| Formulation^{a} | Time, hr | Sa | Pa | Sm | Ca | Fs |
|---|---|---|---|---|---|---|
| 2a | 0.5 | 4.1 | >4.6 | 2.7 | 0.6 | 1.8 |
| | 4 | >4.8 | >4.6 | >4.7 | 0.6 | 2.7 |
| 2b | 0.5 | 0.9 | ND | 1.1 | 0.3 | 0.3 |
| | 4 | 1.8 | ND | 1.8 | 1.3 | 2.0 |
| 2c | 0.5 | >4.8 | >4.6 | >4.7 | 0.5 | 3.0 |
| | 4 | >4.8 | >4.6 | >4.7 | 1.8 | >4.2 |

^{a}All samples were tested with 10% organic soil.

As indicated by the data of Tables A and B, the effect of having both decanoylglycerol and polyquatemium-1 in a lens care formulation is somewhat less effective than a similar lens care formulation containing both PHMB and decanoylglycerol. In particular, the data of Table B suggests that the formulation with polyquatemium-1 is less effective against Ca and Fs than formulations with PHMB.

TABLE 3
Formulations containing PHMB and octanoylglycerol.

| | % w/w | | |
|---|---|---|---|
| Ingredient | Formulation 3a | Formulation 3b | Formulation 3c |
| Sodium phosphate | 0.280 | 0.280 | 0.280 |
| dibasic heptahydrate | | | |
| Sodium phosphate | 0.056 | 0.056 | 0.056 |
| monobasic | | | |
| monohydrate | | | |
| Sodium chloride | 0.780 | 0.780 | 0.780 |
| Octanoylglycerol | — | 1000 ppm | 1000 ppm |
| PHMB | 0.5 ppm | — | 0.5 ppm |
| Water | q.s. to 100% | q.s. to 100% | q.s. to 100% |
| pH | 7.1-7.5 | 7.1-7.5 | 7.1-7.5 |
| Osmolality, mOsm/kg | 280-320 | 280-320 | 280-320 |

TABLE C
Biocidal efficacy of formulations 3a, 3b and 3c.

| Formulation^{a} | Time, hr | Sa | Pa | Sm | Ca | Fs |
|---|---|---|---|---|---|---|
| 3a | 1 | 2 | 2.8 | 2.1 | 0.6 | 0.3 |
| | 4 | 2.8 | 2.8 | 2.7 | 0.6 | 0.3 |
| 3b | 1 | 0.6 | 1.2 | 0.9 | 0.7 | 0.4 |
| | 4 | 0.6 | 2.3 | 1.2 | 0.5 | 0.4 |
| 3c | 1 | 3.1 | >4.8 | 3 | 0.5 | 0.6 |
| | 4 | >4.9 | >4.8 | >4.9 | 0.7 | 0.6 |

^{a}All samples were tested with 10% organic soil.

As indicated by the data of Table C, the effect of adding octanoylglycerol to a lens care formulation containing poly(hexamethylene biguanide) is particularly effective against three microorganisms Sa, Pa and Sm.

TABLE 4
Formulations containing Polyquaternium-1 and octanoylglycerol.

| | % w/w | | |
|---|---|---|---|
| Ingredient | Formulation 4a | Formulation 4b | Formulation 4c |
| Sodium phosphate | 0.280 | 0.280 | 0.280 |
| dibasic heptahydrate | | | |
| Sodium phosphate | 0.056 | 0.056 | 0.056 |
| monobasic | | | |
| monohydrate | | | |
| Sodium chloride | 0.780 | 0.780 | 0.780 |
| Octanoylglycerol | — | 1000 ppm | 1000 ppm |
| Polyquaternium-1 | 1 ppm | — | 1 ppm |
| Water | q.s. to 100% | q.s. to 100% | q.s. to 100% |
| pH | 7.1-7.5 | 7.1-7.5 | 7.1-7.5 |
| Osmolality, mOsm/kg | 280-320 | 280-320 | 280-320 |

TABLE D
Biocidal efficacy of formulations 4a, 4b and 4c.

| Formulation^{a} | Time, hr | Sa | Pa | Sm | Ca | Fs |
|---|---|---|---|---|---|---|
| 4a | 1 | 0.7 | 0.7 | 0.9 | 0.5 | 0.8 |
| | 4 | 0.7 | 0.7 | 0.9 | 0.6 | 1.3 |
| 4b | 1 | 0.6 | 1.2 | 0.9 | 0.7 | 0.4 |
| | 4 | 0.6 | 2.3 | 1.2 | 0.5 | 0.4 |
| 4c | 1 | 4.1 | 4.8 | 4.4 | 0.4 | 0.6 |
| | 4 | >4.9 | 4.8 | >4.9 | 0.5 | 0.8 |

^{a}All samples were tested with 10% organic soil.

As indicated by the data of Table D, the effect of adding octanoylglycerol to a lens care formulation containing polyquaternium-1 is particularly effective against three microorganisms Sa, Pa and Sm.

As indicated by the data reported in Tables A, B C and D, the presence of decanoylglycerol and octanoylglycerol in lens care formulations containing a cationic disinfectant, particularly polyquaternium-1 and polyhexamethylene biguanide provide an unexpected enhancement in antimicrobial activity. Moreover, the presence of these fatty acid monoesters allows one of ordinary skill to prepare lens care solutions with relatively lower amounts of cationic antimicrobial components than required if the fatty acid monoesters were not present. As a result, these lens care solutions are expected to cause less eye irritation, yet provide similar, or even greater, antimicrobial efficacy.

### EXAMPLE 3

PHMB (Polyamino propyl Biguanide Hydrochloride, 2 g, 0.0011 mole,) and HMBDA (1,6-bis(cyanoguanadino)hexane, 0.3 g, 0.0012 mole were mixed and ground together, then placed in a 100 mL round bottom flask. Concentrated Hydrochloric acid (100 μL) was then added to the PHMB/HMBDA. The mixture was slowly heated to 100° C. until all the liquid was driven off. The heat was then increased to 150° C. to 160° C. and held for 4 hours. The reaction mixture was cooled to room temperature providing 1.32 g of the crystalline material PHMB-CG*.

We claim:

1. A method of disinfecting, cleaning or packaging a contact lens by contacting the lens with an ophthalmically acceptable lens care composition, the composition comprising:
a fatty acid monoester, wherein the fatty acid monoester comprises an aliphatic fatty acid portion having six to fourteen carbon atoms, and an aliphatic hydroxyl portion;
and a cationic antimicrobial component.

2. The method of claim 1 wherein the cationic antimicrobial component is selected from the group consisting of poly(hexamethylene biguanide) or PHMB-CG*, which is present from 0.01 ppm to 3 ppm, α-[4-tris(2-hydroxyethyl)ammonium chloride-2-butenyl]poly[1-dimethylammonium chloride-2-butenyl]-ω-tris(2-hydroxyethyl)ammonium chloride, which is present from 1 ppm to 100 ppm, and any mixture thereof.

3. The method of claim 1 wherein the aliphatic fatty acid portion is a straight chain, saturated or unsaturated hydrocarbon with eight to ten carbons, or a branched chain, saturated or unsaturated hydrocarbon with eight to ten carbons.

4. The method of claim 1 wherein the aliphatic hydroxyl portion is a linear polyol selected from the group consisting of mannitol, sorbitol and derivatives thereof.

5. The method of claim 1 wherein the fatty acid monoester is selected from the group consisting of octanoylglycerol, decanoylglycerol and mixtures thereof.

6. An ophthalmically acceptable, lens care composition comprising:
a fatty acid monoester, wherein the fatty acid monoester comprises an aliphatic fatty acid portion having six to fourteen carbon atoms, and an aliphatic hydroxyl portion; and a cationic antimicrobial component.

7. The composition of claim 6 wherein the cationic antimicrobial component is selected from the group consisting of poly[dimethylimino-2-butene-1,4-diyl]chloride, α-[4-tris(2-hydroxyethyl)ammonium chloride-2-butenyl]poly[1-dimethylammonium chloride-2-butenyl]-ω-tris(2-hydroxyethyl)ammonium chloride, myristamidopropyl dimethylamine, benzalkonium halides, alexidine and salts thereof, salts of chlorhexidine, hexamethylene biguanides and salts thereof and their polymers, and mixtures thereof.

8. The composition of claim 6 wherein the cationic antimicrobial component is selected from the group consisting of poly(hexamethylene biguanide) or PHMB-CG*, which is present from 0.01 ppm to 3 ppm, α-[4-tris(2-hydroxyethyl)ammonium chloride-2-butenyl]poly[1-dimethylammonium chloride-2-butenyl]-ω-tris(2-hydroxyethyl)ammonium chloride, which is present from 1 ppm to 100 ppm, and any mixture thereof.

9. The composition of claim 6 wherein the aliphatic fatty acid portion is a straight chain, saturated or unsaturated hydrocarbon with eight to ten carbons, or a branched chain, saturated or unsaturated hydrocarbon with eight to ten carbons.

10. The composition of claim 9 wherein the aliphatic hydroxyl portion is glycerol.

11. The composition of claim 6 further comprising dexpanthenol, sorbitol or any combination thereof.

12. The composition of claim 6 further comprising a viscosity inducing components selected from the group consisting of guar gum, hydroxypropyl cellulose, hydroxypropylmethyl cellulose and hydroxyethyl cellulose.

13. The composition of claim 6 wherein the fatty acid monoester is selected from the group consisting of octanoylglycerol, decanoylglycerol and mixtures thereof.

14. The use of the ophthalmically acceptable, lens care compositions of claim 6 to clean, disinfect or store contact lenses.

15. A method for enhancing the efficacy of a cationic disinfectant in a contact lens care formulation, the method comprising adding a fatty acid monoester, wherein the fatty acid monoester comprises an aliphatic fatty acid portion having ten carbon atoms, and an aliphatic hydroxyl portion, to a lens care formulation containing the cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-α-tris(2-hydroxyethyl)ammonium chloride, myristamidopropyl dimethylamine and any mixture thereof, said efficacy of the lens care formulation enhanced against Candida albicans or Fusarium solani.

16. The method of claim 15 wherein the fatty acid monoester is selected from the group consisting of octanoylglycerol, decanoylglycerol and mixtures thereof.

17. An ophthalmically acceptable, lens care composition comprising:
a fatty acid monoester, wherein the fatty acid monoester comprises an aliphatic fatty acid portion having ten carbon atoms, and an aliphatic hydroxyl portion; and
a cationic disinfectant selected from the group consisting of poly(hexamethylene biguanide), PHMB-CG*, α-[4-tris(2-hydroxyethyl)ammonium chloride-2-butenyl]poly[1-dimethylammonium chloride-2-butenyl]-ω-tris(2-hydroxyethyl)ammonium chloride and any mixture thereof, said ophthalmically acceptable, aqueous solution characterized by an enhanced efficacy against Candida albicans or Fusarium solani.

18. The composition of claim 17 wherein the fatty acid monoester is selected from the group consisting of octanoylglycerol, decanoylglycerol and mixtures thereof.

19. The composition of claim 17 further comprising dexpanthenol, sorbitol or any combination thereof.

20. The composition of claim 17 further comprising a viscosity inducing components selected from the group consisting of guar gum, hydroxypropyl cellulose, hydroxypropylmethyl cellulose and hydroxyethyl cellulose.
